(19) United States
(12) Patent Application Publication
(10) Pub. No.: US 2025/0096349 A1
(43) Pub. Date: Mar. 20, 2025

(54) BATTERY UNIT

(71) Applicant: Robert Bosch GmbH, Stuttgart (DE)

(72) Inventor: Markus Schmitt, Tamm (DE)

(21) Appl. No.: 18/890,866

(22) Filed: Sep. 20, 2024

(30) Foreign Application Priority Data
Sep. 20, 2023 (DE) 10 2023 209 171.2

(51) Int. Cl. H01M 10/6551; H01M 10/613; H01M 10/625; H01M 10/6552; H01M 10/6569; H01M 50/249; H02J 7/00

(52) U.S. Cl. CPC H01M 10/6551; H01M 10/613; H01M 10/625; H01M 10/6552; H01M 10/6569; H01M 50/249; H02J 7/0031; H02J 2207/20

(57) ABSTRACT

A battery unit having a cooling device for dissipating heat includes a fluid-tight battery housing, a battery cell stack, and a battery disconnect unit having power electronics. The cooling device has a heat sink and at least one heat pipe. The battery cell stack, the battery disconnect unit, and the heat pipe are disposed in the battery housing. The battery cell stack and the battery disconnect unit are electrically connected to each other, and the heat pipe is thermally connected to the power electronics of the battery disconnect unit. The heat sink is disposed on an outer side of the battery housing, and the battery housing includes a heat sink opening. A connecting element of the heat sink extends into the battery housing via the heat sink opening, and the connecting element is thermally connected to the at least one heat pipe to discharge heat generated in operation.

### BACKGROUND

The invention relates to a battery unit.

In general, individual battery cells are connected together to form battery modules, wherein said battery modules are connected together to form batteries or battery systems. Due to the variety of different installation spaces in vehicles, variable module sizes are required. This is the only way to optimally utilize the available installation space.

DE 10 2019 205 388, DE 10 2019 214 199, and DE 10 2019 215 338 describe how the cooling of a battery disconnect unit, also known as a DC breaker, can be implemented by means of a direct thermal connection to a cooling channel of a metal battery housing (heat sink). The DC breaker is coupled to the metal housing in direct proximity of the cooling channel by means of a thermally conductive medium.

In DE 10 2021 204 787, it is described how the cooling of a battery disconnect unit can be implemented by means of an indirect thermal connection to a cooling channel of a metal battery housing (heat sink). The housing part to which the battery disconnect unit is thermally coupled by means of a thermally conductive medium serves as a thermally conductive structure. The actual cooling channel is integrally implemented on a further housing component. Said component is then thermally coupled to the first housing component by means of a thermally conductive medium. Again, the housing components are made from a metal alloy in order to achieve good cooling of the battery disconnect unit.

DE 10 2021 204 696 describes how the cooling of a battery disconnect unit by means of an indirect thermal bond can be implemented by means of a thermal conduction plate to a cooling channel integrated in the housing. In contrast to DE 10 2021 204 787, the cooling channel is integrated in the housing on which the thermal conduction plate is mechanically and thermally connected.

It is common to all that the battery housing must be made of a material having a high thermal conductivity in order to conduct the heat from the battery disconnect unit to the heat sink. This is preferably achieved by an aluminum housing.

However, due to the material used, the location of the heat sink is not freely selectable. At the same time, the use of metals, such as aluminum, is costly and limited in design choices.

### SUMMARY

A first aspect of the invention is a battery unit having a cooling device for dissipating the heat generated while supplying a consumer, in particular a motor vehicle, with energy, comprising a fluid-tight battery housing, a battery cell stack, and a battery disconnect unit having power electronics, wherein the cooling device comprises a heat sink and at least one heat pipe, wherein the battery cell stack, the battery isolating unit, and the at least one heat pipe of the cooling device are disposed in the battery housing, wherein the battery cell stack and the battery disconnect unit are electrically connected to each other, and wherein the at least one heat pipe of the cooling device is in particular directly thermally connected to the power electronics of the battery disconnect unit, wherein the heat sink is disposed on an outer side of the battery housing, and wherein the battery housing has a heat sink opening, wherein at least one connection element of the heat sink projects into the battery housing via the heat sink opening, and wherein the connection element of the heat sink is thermally connected to the at least one heat pipe of the cooling device in order to dissipate the heat generated during operation to the outer side.

In a particularly advantageous configuration, there is a direct connection between the heat pipe and the power electronics, leading to a direct thermal contact between the electronic components (here Mosfets) on the printed circuit board and the heat pipe.

The battery housing may be embodied as a plastic injection molding housing. No additional measures for electrical insulation between the cell stack and housing are then necessary. In addition, the use of plastic for the battery housing offers the advantage that there is great freedom in the design as well as a weight advantage over metal housings.

Because plastics generally have a very low thermal conductivity, they are not suitable for being used as a heat sink for cooling components. However, by using plastic, the design freedom for the housing is increased so that said housing can be optimally adapted to the existing installation space. Therefore, a heat sink outer side the internal space of the battery for cooling the DC breaker or the battery disconnect unit is preferable when using a plastic housing. Heat sinks having a high thermal conductivity and a large surface area are then used for transferring heat to the surrounding air. In this context, aluminum or copper alloys having a high thermal conductivity are preferably used.

Depending on the requirement for cooling of the battery disconnect unit, the heat transfer to the surrounding air may be carried out by free convection or, for higher requirements, by means of forced convection, for example by means of a blower.

By using heat pipes for conducting heat from the heat source to the heat sink during cooling of the battery disconnect unit optimum cooling with a very low temperature delta between the cooling medium and the battery disconnect unit can be achieved.

At the same time, the positioning of the heat sink on the outer side of the battery housing can be freely chosen by the use of the heat pipes, as such heat pipes also function opposite to the force of gravity. Furthermore, the heat sink, present here as the cooling body, may be selected freely or according to the requirements and installation space, because said heat sink is no longer implemented as an integral component of the battery housing.

The electrical connection between the battery disconnect unit and the battery cell stack is made by means of a busbar. The busbar is thereby soldered onto dedicated pads to ensure electrical contact.

In the present case, a metal vessel having an elongate shape and containing a hermetically encapsulated volume is understood as a heat pipe. The heat pipe is filled with a working medium (e.g. water or ammonia) filling the volume with liquid to a small extent and in the gaseous state to a greater extent.

The point on the vessel serving to absorb energy is referred to as the vaporizer, and the points serving to emit energy are called condensers. The vaporizer may be at one end or in the middle. In the present case, the region of the heat pipe connected to the power electronics is the vaporizer. The region of the heat pipe connected to the connection element of the heat sink is the condenser.

In the context of the invention, it may be advantageous that the at least one heat pipe has a 90° deflection and that the connecting element is thermally connected over at least a part of a peripheral surface of the at least one heat pipe.

The deflection of the at least one heat pipe allows a space-saving design of the cooling device in the battery housing. For connecting the connecting element across the peripheral surface of the heat pipe, a connection surface of the connecting element may at least partially correspond to the peripheral surface. The connection surface thus encloses the peripheral surface, for example by at least 50%, preferably at least 60%, further preferably at least 70%.

In the context of the invention, it is contemplated that the at least one heat pipe has a flat connection region for thermally connecting to the power electronics of the battery disconnect unit.

The surface area of the connection region of the heat pipe corresponds to at least the surface area of the power electronics, or of the at least one component of the power electronics. The connection region is thus the vaporizer of the heat pipe, wherein flattening the heat input from the source, i.e. the power electronics of the battery disconnect unit, over the entire surface area of the power electronics, ensures that rapid cooling and heat dissipating can take place.

It may be provided in the context of the invention that a thermally conductive medium is provided between the power electronics and the at least one heat pipe and/or between the at least one heat pipe and the connecting element of the heat sink.

The use of a thermally conductive medium provides thermal contact between the power electronics and the at least one heat pipe and/or between the at least one heat pipe and the connecting element. In so doing, the thermally conductive medium provides for improving the heat transfer between the elements involved, each having different temperatures.

It is further contemplated that a pressing element is provided for positioning and pressing the at least one heat pipe on the power electronics of the battery disconnect unit.

The pressing element ensures that the heat pipe is also held in position on the power electronics during operation. Said element therefore also ensures optimum cooling of the power electronics.

It is also contemplated that the pressing element has a resilient region.

The resilient region ensures that tolerance ranges of the at least one heat pipe can be compensated for, or that even with somewhat raised components on the power electronics, the at least one heat pipe contacts the power electronics with as much surface area as possible in order to be able to optimally discharge the heat.

In the context of the invention, it is optionally possible for the heat sink of the cooling device to comprise at least two, preferably at least five, further preferably at least eight, cooling fins.

By means of the cooling fins, the heat transfer surface may be increased. The number of cooling fins can be selected as a function of the power and the associated heat generation of the power electronics. Care should also be taken with the spacing between the cooling fins, which should be selected so that at least one cooling fin fits within the spacing. This ensures convection, and thus heat dissipation.

Furthermore, it may be provided in the context of the invention that the at least one connecting element at least partially receives the at least one heat pipe, wherein the geometry of the connecting element corresponds to the geometry of the heat pipe.

This allows optimal heat transfer from the heat pipe to the connecting element. In said region, the heat pipe acts as a condenser. It is particularly advantageous here if both the heat pipe and the connecting element have a cylindrical shape. A uniform heat transfer from the heat pipe to the heat sink via the connecting element is thereby generated.

With respect to the present invention, it is contemplated that the battery housing has a sealing groove circumferential around the heat sink opening and having a seal for closing off the battery housing in a fluid-tight manner when the heat sink of the cooling device is assembled.

When mounting the cooling device or heat sink of the cooling device in the heat sink opening, the seal is pushed into the sealing groove so that the battery housing is closed off in a fluid-tight manner so that neither liquid can escape from the battery housing towards the environment nor liquid from the environment can enter the battery housing. The seal increases the safety of the battery unit while allowing for a fluid-tight design between the cooling device and the battery housing to pass heat from the interior of the battery housing to the environment.

It is further contemplated that at least two, preferably at least three, preferably at least four, alignment elements are provided on the outer side of the battery housing and that corresponding alignment openings are provided on the heat sink in the region of the alignment elements, wherein the alignment openings are configured to receive the alignment elements for positioning the heat sink on the battery housing.

This increases the reliability of properly aligning the heat sink of the cooling device and thus the entire cooling device in the battery housing. The alignment elements, and the alignment holes respectively, serve to facilitate and secure screwing and sealing of the battery housing.

In the context of the invention, it may be advantageous for the heat sink to be an extrusion heat sink.

Said heat sinks are simple and cost efficient to manufacture. At the same time, the shape can be adapted to the structural conditions due to the simplicity of manufacturing, so that the design freedom of the entire battery unit is also thereby increased.

In the context of the invention, it is contemplated that a support frame is provided for supporting the battery disconnect unit, wherein the support frame is connected to a web of the battery housing in a force-fit manner.

The mounting height of the battery disconnect unit in the battery housing can thereby be defined and fixed. This simplifies the selection of busbars provided for the electrical connection.

It may be contemplated in the context of the invention that the pressing element is connected to the support frame.

This allows a simple positioning of the pressing element with respect to the heat pipe to be pressed towards the power electronics.

### BRIEF DESCRIPTION OF THE DRAWINGS

Further advantages, features, and details of the invention follow from the description hereinafter, in which multiple exemplary embodiments of the invention are described in detail with reference to the drawings. In this context, the features mentioned in the claims and in the description may each be essential to the invention individually or in any combination. The invention is illustrated in the following drawings:

FIG. 1 is a schematic representation of a battery unit,

FIG. 2 is a schematic representation of a battery unit,

FIG. 3 is a schematic representation of a battery unit, and

FIG. 4 is a schematic representation of a battery unit.

### DETAILED DESCRIPTION

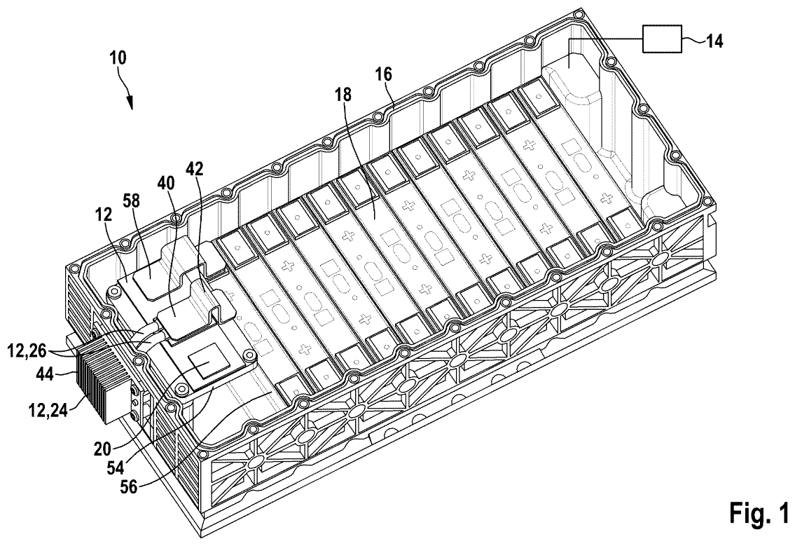

In FIG. 1 to FIG. 4, a battery unit 10 having a cooling device 12 for dissipating the heat generated while supplying a consumer 14 with energy, in particular a motor vehicle, is shown. The battery unit 10 comprises a fluid-tight battery housing 16, a battery cell stack 18, and a battery disconnect unit 20 having power electronics 22. The cooling device 12 additionally provides a heat sink 24 and at least one heat pipe 26.

The battery cell stack 18, the battery disconnect unit 20, and the at least one heat pipe 26 of the cooling device 12 are disposed in the battery housing 16, wherein the battery cell stack 18 and the battery disconnect unit 20 are electrically connected to each other. For better stability or to ensure a simple electrical connection, the battery disconnect unit 20 is disposed here on a support frame 54. This connection is made by means of a bus bar 58. In so doing, the support frame 54 for supporting the battery disconnect unit 20 is connected to a web 56 of the battery housing 16 in a force-fit manner. The battery disconnect unit 20 is connected to the support frame 54 by means of various hot staking points.

The at least one heat pipe 26 of the cooling device 12 is thermally connected to the power electronics 22 of the battery disconnect unit 20. In the present exemplary embodiment, two heat pipes 26 are used for the heat dissipation or cooling of the power electronics 22.

The heat sink 24 of the cooling device 12 is disposed on an exterior 28 of the battery housing 16 so that good heat exchange with the surrounding air is ensured.

For this purpose, the battery housing 16 comprises a heat sink opening 30, wherein at least one connecting element 32 of the heat sink 24 extends into the battery housing 16 via the heat sink opening 30. The projecting part, i.e. the connection element 32 of the heat sink 24, is thermally connected to the at least one heat pipe 26 of the cooling device 12 in order to outwardly dissipate the heat generated during operation.

The battery housing 16 is embodied as a plastic injection molding housing in the embodiment shown. This has the advantage that no additional measures for electrical insulation are necessary between the battery cell stack 18 and the battery housing 16. In addition, the use of plastic for the battery housing 16 offers the advantage that there is great freedom in the design as well as a weight advantage over metal housings. The heat sink 24 of the cooling device 12 is embodied in the present case as extrusion heat sinks.

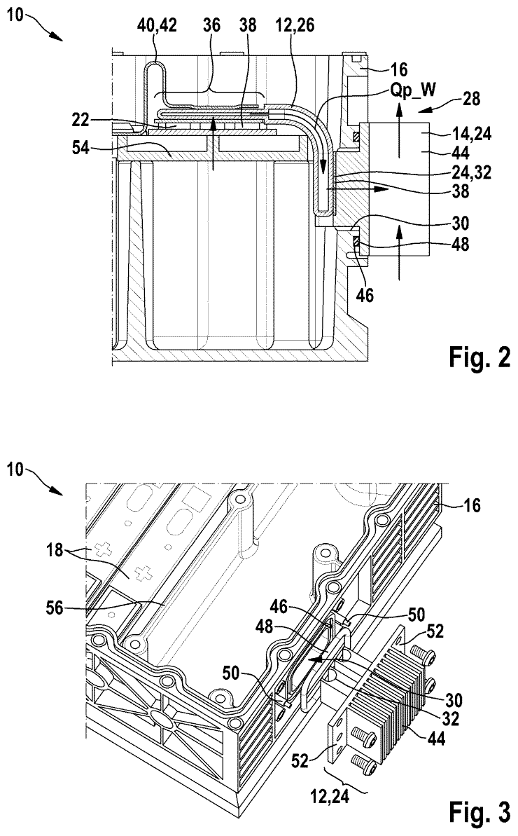

For a space-saving design of the cooling device 12 and to ensure the flexibility of the positioning of the heat sink 24 or to achieve the position as in the exemplary embodiment shown, the at least one heat pipe 26 has a 90° deflection. At the same time, the connecting element 32 is thermally connected via at least a portion of a peripheral surface 34 of the at least one heat pipe 26 to ensure heat dissipation, as seen in FIG. 2. The at least one connecting element 32 receives the at least one heat pipe 26 at least partially in a form-fit manner, wherein the geometry of the connecting element 32 corresponds to the geometry of the heat pipe 26. In the present exemplary embodiment, the two heat pipes 26 are cylindrical and the connecting elements 32 are hollow cylinders, so that a cylindrical contact surface is formed.

A thermally conductive medium 38 is provided between the at least part of a peripheral surface 34 of the at least one heat pipe 26 and the connecting element 32.

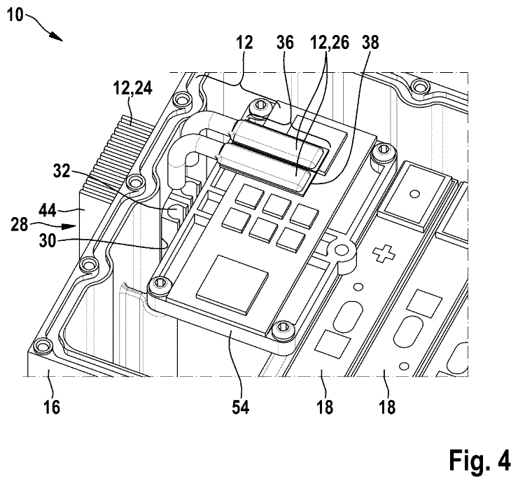

It can be seen in FIG. 2 and FIG. 4 that the at least one heat pipe 26 has a flat connection region 36 for thermally connecting to the power electronics 22 of the battery disconnect unit 20. The contact surface between the connection region 36 and the power electronics 22 at least corresponds to the surface of the power electronics 22 in order to ensure an optimum heat input into the respective heat pipe 26. In addition, a thermally conductive medium 38 is provided between the connection region 36 and the power electronics 22 to improve the heat discharge.

A pressing element 40 having a resilient region 42 is provided for positioning and pressing the at least one heat pipe 26 on the power electronics 22 of the battery disconnect unit 20. The pressing element 40 is connected to the support frame 54.

In FIG. 2, the thermal path is shown from the battery disconnect unit 20 to the heat sink, that is, to the cooling body 24. The heat from the power electronics 22 passes through the thermally conductive medium 38 into the heat pipe 26. In so doing, the pressing element 40 provides good thermal contact between the heat pipe 26, the thermally conductive medium 38, and the power electronics 22. This results in the liquid in the heat pipe 26 being vaporized and the heat flow Qp_W passing through the heat pipe 26 to the heat sink 24 at a very small temperature difference. The heat reaches the heat sink 24 via the thermally conductive medium 38 between the heat pipe 26 and the connection element 32 of the heat sink 24. For optimal heat transfer, the heat sink 24 of the cooling device 12 comprises at least two, preferably at least five, further preferably at least eight, cooling fins 44. The heat transfer at the cooling fins 44 then takes place to the surrounding air either by free or forced convection as required.

In order to make the battery housing 16 fluid-tight, a sealing groove 46 running around the heat sink opening 30 is provided with a seal 48, see FIGS. 2 and 3.

When assembling the heat sink 24, see FIG. 3, the seal 48 is inserted into the sealing groove 46 for sealing the heat sink 24 in or on the battery housing 16. The heat sink 24 is positioned on the battery housing 16 via the at least two, preferably at least three, further at least four, alignment elements 50 provided on the outer side 28 of the battery housing 16. For this purpose, corresponding alignment openings 52 are provided on the heat sink 24 for the alignment elements 50, wherein the alignment openings 52 are configured to receive the alignment elements 50 for positioning the heat sink 24 on the battery housing 16. By tightening the screw connection, the seal 48 is compressed and thus fluid-tight.

1. A battery unit (10) having a cooling device (12) for dissipating heat generated while supplying energy to a consumer (14), the battery unit (10) comprising
a fluid-tight battery housing (16),
a battery cell stack (18), and
a battery disconnect unit (20) having power electronics (22),
wherein the cooling device (12) comprises a heat sink (24) and at least one heat pipe (26),
wherein the battery cell stack (18), the battery disconnect unit (20), and the at least one heat pipe (26) of the cooling device (12) are disposed in the battery housing (16),
wherein the battery cell stack (18) and the battery disconnect unit (20) are electrically connected to each other, and
wherein the at least one heat pipe (26) of the cooling device (12) is thermally connected to the power electronics (22) of the battery disconnect unit (20), wherein the heat sink (24) is disposed on an outer side (28) of the battery housing (16), and
wherein the battery housing (16) comprises a heat sink opening (30), wherein at least one connecting element (32) of the heat sink (24) extends into the battery housing (16) via the heat sink opening (30), and wherein the at least one connecting element (32) of the heat sink (24) is thermally connected to the at least one heat pipe (26) of the cooling device (12) for dissipating heat generated in operation.

2. The battery unit (10) according to claim 1, wherein the at least one heat pipe (26) comprises a 90° deflection and the at least one connecting element (32) is thermally connected over at least a part of a peripheral surface (34) of the at least one heat pipe (26).

3. The battery unit (10) according to claim 1, wherein the at least one heat pipe (26) comprises a flat connection region (36) for thermally connecting to the power electronics (22) of the battery disconnect unit (20).

4. The battery unit (10) according to claim 1, wherein a thermally conductive medium (38) is provided between the power electronics (22) and the at least one heat pipe (26) and/or between the at least one heat pipe (26) and the at least one connecting element (32).

5. The battery unit (10) according to claim 1, wherein a pressing element (40) is provided to position and press the at least one heat pipe (26) on the power electronics (22) of the battery disconnect unit (20).

6. The battery unit (10) according to claim 5, wherein the pressing element (40) has a resilient region (42).

7. The battery unit (10) according to claim 1, wherein the heat sink (24) of the cooling device (12) comprises at least two cooling fins (44).

8. The battery unit (10) according to claim 1, wherein the at least one connecting element (32) at least partially receives the at least one heat pipe (26), wherein a geometry of the at least one connecting element (32) corresponds to a geometry of the at least one heat pipe (26).

9. The battery unit (10) according to claim 1, wherein the battery housing (16) has a circumferential sealing groove (46) about the heat sink opening (30) having a seal (48) for closing off the battery housing (16) in a fluid-tight manner when the heat sink (24) of the cooling device (12) is assembled.

10. The battery unit (10) according to claim 1, wherein at least two alignment elements (50) are provided on the outer side (28) of the battery housing (16), and wherein alignment openings (52) corresponding to the at least two alignment elements (50) are provided on the heat sink (24), wherein the alignment openings (52) are configured to receive the at least two alignment elements (50) for positioning the heat sink (24) on the battery housing (16).

11. The battery unit (10) according to claim 1, wherein the heat sink (24) is an extruded heat sink.

12. The battery unit (10) according to claim 1, wherein a support frame (54) is provided for supporting the battery disconnect unit (20), wherein the support frame (54) is connected to a web (56) of the battery housing (16) in a force-fit manner.

13. The battery unit (10) according to claim 12, wherein a pressing element (40), provided to position and press the at least one heat pipe (26) on the power electronics (22) of the battery disconnect unit (20), is connected to the support frame (54).

14. The battery unit (10) according to claim 1, wherein the consumer is a motor vehicle.

15. The battery unit (10) according to claim 7, wherein the heat sink (24) of the cooling device (12) comprises at least five cooling fins (44).

16. The battery unit (10) according to claim 15, wherein the heat sink (24) of the cooling device (12) comprises at least eight cooling fins (44).

17. The battery unit (10) according to claim 10, wherein at least three alignment elements (50) are provided on the outer side (28) of the battery housing (16).

18. The battery unit (10) according to claim 17, wherein at least four alignment elements (50) are provided on the outer side (28) of the battery housing (16).
